(19) United States
(12) Patent Application Publication
(10) Pub. No.: US 2025/0227790 A1
(43) Pub. Date: Jul. 10, 2025

(54) COMMUNICATION DEVICE AND NON-TRANSITORY COMPUTER READABLE STORAGE MEDIUM

(71) Applicant: CANON KABUSHIKI KAISHA, Tokyo (JP)

(72) Inventor: DAISUKE KAWAKAMI, Tokyo (JP)

(21) Appl. No.: 18/976,461

(22) Filed: Dec. 11, 2024

(30) Foreign Application Priority Data
Jan. 10, 2024 (JP) 2024-002046

(51) Int. Cl. H04W 76/15

(52) U.S. Cl. CPC H04W 76/15

(57) ABSTRACT

A communication device establishes a plurality of communication links with another communication device, obtains information indicating whether or not the another communication device is capable of executing communication using a predetermined communication method in which, while maintaining the plurality of communication links, communication is performed selectively using a portion of the plurality of communication links and not using a remaining portion of the plurality of communication links and communication unit configured to, in a case where the another communication device is capable of executing communication using the predetermined communication method, and communication using the predetermined communication method is to be executed, starts communication using the predetermined communication method based on control performed by the another communication device.

### BACKGROUND OF THE INVENTION

### Field of the Invention

The present invention relates to a data communication technique in a communication device capable of using multiple links in parallel.

### Description of the Related Art

Increases in the amount of data being communicated in recent years have been accompanied by progress in the development of communication technologies in wireless LANs (Local Area Networks) and the like. The Institute of Electrical and Electronics Engineers (IEEE) 802.11 standard series is known as a main communication standard for wireless LANs. The IEEE 802.11 standard series includes standards such as IEEE 802.11a/b/g/n/ac/ax. For example, the latest standard, IEEE 802.11ax, standardizes technology that uses orthogonal frequency-division multiple access (OFDMA) to achieve a high peak throughput of up to 9.6 gigabits per second (Gbps) while also improving communication speeds in congested situations. Note that OFDMA is an abbreviation for “orthogonal frequency-division multiple access”.

In order to develop a successor standard that aims to further improve throughput and also improve frequency utilization efficiency and communication latency, a new task group for developing the IEEE 802.11be standard has been established within the IEEE 802.11 working group. This task group is considering multi-link communication as one new feature to be specified in the IEEE 802.11be standard. In multi-link communication, a communication device called a multi-link device (MLD) uses multiple links in parallel by linking and coordinating multiple communication interfaces. Japanese Patent Laid-Open No. 2023-51567 discloses enhanced multi-link multi-radio (EMLMR) technology in which, for each link in multi-link communication, initial frame exchange is performed using a predetermined number of spatial streams, and then frame exchange is executed on the link. On the other hand, the IEEE 802.11be standard is expected to specify EMLSR, which is a form of multi-link communication in which, while maintaining multiple links established between MLDs, communication is performed using one link at a time. EMLSR is an abbreviation for enhanced multi-link single radio.

When multi-link communication is performed, the amount of power consumed by the communication device is higher than when communication is performed using one link. When using EMLSR, in which communication is performed using one link at a time, it is possible to reduce the power consumption of the communication device. Also, since EMLSR selectively uses one link from among multiple links, in a congested communication environment, for example, it is possible to improve the communication performance (e.g., a delay characteristic) by appropriately selecting an available link. However, there is also a possibility that communication performance and power efficiency may be improved by performing multi-link communication. For example, by performing high-speed communication using multi-link communication, delay may be reduced, and power consumption may also be suppressed. In this way, although the use of EMLSR improves communication performance and power efficiency in some cases, there may also be cases where the communication performance and power efficiency are not improved due to the extra processing that is performed.

### SUMMARY OF THE INVENTION

One aspect of the present disclosure provides a technique for improving communication performance and power efficiency in a system in which multi-link communication capable of using EMLSR is performed.

According to an aspect of the present invention, there is provided a communication device, comprising: an establishing unit configured to establish a plurality of communication links with another communication device; an obtaining unit configured to obtain information indicating whether or not the another communication device is capable of executing communication using a predetermined communication method in which, while maintaining the plurality of communication links, communication is performed selectively using a portion of the plurality of communication links and not using a remaining portion of the plurality of communication links; and a communication unit configured to, in a case where the another communication device is capable of executing communication using the predetermined communication method, and communication using the predetermined communication method is to be executed, start communication using the predetermined communication method based on control performed by the another communication device.

Further features of the present invention will become apparent from the following description of exemplary embodiments with reference to the attached drawings.

### BRIEF DESCRIPTION OF THE DRAWINGS

FIG. 1 is a diagram showing an example of the configuration of a wireless communication system.

FIG. 2 is a diagram showing an example of a sequence between an AP and an STA when establishing multi-link communication.

FIG. 3 is a diagram showing an example of the configuration of a Reduced Neighbor Report element.

FIG. 4 is a diagram showing an example of a flow of operations performed when the STA executes EMLSR.

FIG. 5 is a diagram showing an example of the hardware configuration of a communication device.

FIG. 6 is a diagram showing an example of the functional configuration of the communication device.

FIG. 7 shows an example of a flow of operations performed when the STA executes EMLSR.

FIG. 8 is a diagram showing an example of a flow of operations performed when the STA executes EMLSR.

FIG. 9 is a diagram showing an example of a flow of operations performed when the STA executes EMLSR.

FIG. 10 is a diagram showing an example of a flow of operations performed when the AP executes EMLSR.

FIG. 11 is a diagram showing an example of a flow of operations performed when the STA executes EMLSR.

FIG. 12 shows an example of a flow of operations performed when the STA executes EMLSR.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### System Configuration

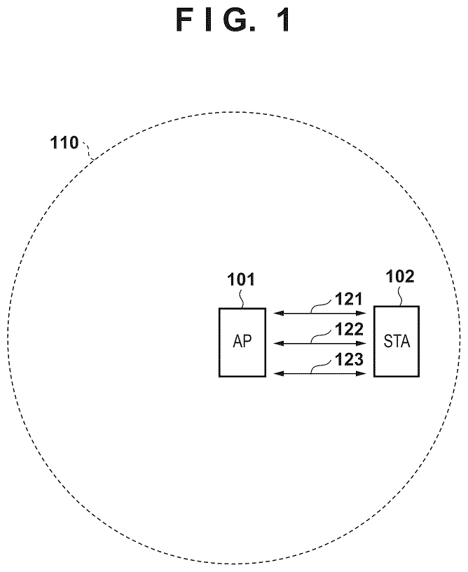

FIG. 1 shows an example of the configuration of a wireless communication system according to the present embodiment. This wireless communication system includes, for example, one access point (AP) 101 and one station (STA) 102. The AP 101 and the STA 102 are wireless communication devices capable of performing wireless communication conforming to the IEEE 802.11 standard series, which includes the IEEE 802.11be standard. Note that IEEE is an abbreviation for the Institute of Electrical and Electronics Engineers. The IEEE 802.11be standard may also be referred to as the EHT standard. EHT may be an abbreviation for Extremely High Throughput. The IEEE 802.11 standard series may include IEEE 802.11a/b/g/n/ac/ax standards. These standards may be referred to as legacy standards. In other words, the AP 101 and the STA 102 may support one or more legacy standards in addition to the IEEE 802.11be standard. A network 110 formed by the AP 101 indicates the range in which the AP 101 and the STA 102 can communicate with each other. In other words, within the range of the network 110, the STA 102 can receive signals transmitted by the AP 101, and signals transmitted by the STA 102 can be received by the AP 101. Note that in addition to the IEEE 802.11 standard series, the AP 101 and the STA 102 may also support other communication standards such as Bluetooth (registered trademark), NFC, UWB, ZigBee, and MBOA. Note that UWB is an abbreviation for ultra wide band and MBOA is an abbreviation for multi band OFDM alliance. Also, NFC is an abbreviation for near field communication. UWB includes wireless USB, wireless 1394, WiNET, and the like. Also, the AP 101 and the STA 102 may support a communication standard for wired communication such as a wired LAN.

Although FIG. 1 shows a state in which there is one AP 101 and one STA 102, there may be a plurality of APs 101 and STAs 102. In such a case, multiple STAs 102 may be connected to one AP 101, and one STA 102 may be connected to multiple APs 101. The AP 101 may be, but is not limited to, a wireless LAN router, a personal computer (PC), or the like. Furthermore, the STA 102 may be any electronic device, such as a smartphone, a tablet, a mobile phone, a PC, a video camera, a headset, a printer, or a display, but is not limited to these. The AP 101 and the STA 102 may be information processing devices such as wireless chips capable of performing wireless communication conforming to the IEEE 802.11be standard. In the present embodiment, the AP 101 and the STA 102 may be referred to as communication devices without distinguishing between them.

Multi-link communication is one of new features defined in the IEEE 802.11be standard. In the conventional IEEE 802.11 standard series, the STA 102 establishes a single link with the AP 101, and data communication is performed using that link. In multi-link communication, the STA 102 performs data communication with the AP 101 using two or more links in parallel, thus making it possible to achieve improved throughput. Furthermore, in the IEEE 802.11be standard, support for the 6 GHz band is being considered in order to expand the frequency band available to communication devices. In other words, the IEEE 802.11 standard series specifies the use of the 2.4 GHz, 5 GHz, 6 GHz, and 60 GHz frequency bands, which can be used for multi-link communication. Multiple frequency channels are defined in each frequency band; for example, channels each using a bandwidth of 20 MHz are defined as frequency channels used for one wireless link. In the IEEE 802.11 standard series, adjacent frequency channels can be combined (bonded) together to provide a bandwidth of 40 MHz or more in one frequency channel. For example, the AP 101 can establish a first link with the STA 102 using a first frequency channel in the 5 GHz band and perform communication on that link. The STA 102 can then establish a second link with the AP 101 using a second frequency channel in the 6 GHz band and perform communication on that link. In this case, the AP 101 and the STA 102 execute multi-link communication in which the first link is maintained while using the second link in parallel. Thus, in the present embodiment, the AP 101 and the STA 102 are configured to be able to execute multi-link communication using multiple links in the network 110.

FIG. 1 shows an example in which three wireless links (links 121, 122, and 123) are established between the AP 101 and the STA 102. As mentioned above, the wireless links may be in different frequency bands from each other. For example, the AP 101 and the STA 102 can establish the link 121 using the 5 GHz band, the link 122 using the 6 GHz band, and the link 123 using the 2.4 GHz band in parallel. Furthermore, wireless links may be configured by different frequency channels belonging to the same frequency band. For example, multi-link communication may be performed using two links, one of which uses the channel 15ch in the 6 GHz band and the other of which uses the channel 207ch in the 6 GHz band. In the present embodiment, “ch” is identification information used to identify a specific frequency channel. Furthermore, multi-link communication may be performed using a mixture of both links belonging to the same frequency band and a link belonging to a different frequency band. For example, multi-link communication may be performed with use of the link 121 using the channel 36ch in the 5 GHz band, the link 122 using the channel 149ch in the 5 GHz band, and the link 123 using the channel 15ch in the 6 GHz band. By establishing multiple links using different frequency channels between the AP 101 and the STA 102, even if one of the frequency channels is congested, communication can be performed via a link using another frequency channel. This makes it possible to avoid both a decrease in throughput and an increase in delay.

A communication device capable of performing multi-link communication is called a multi-link device (MLD). A communication device having a function of operating as an AP or an STA conforming to the IEEE 802.11be standard and also having a function of operating as an MLD is called an AP MLD or an STA MLD. An STA MLD may also be referred to as a non-AP MLD. In an AP MLD or an STA MLD, each communication interface (I/F) that constitutes a link may be called an affiliated AP (A-AP) or an affiliated STA (A-STA). An affiliated STA is sometimes called an affiliated non-AP STA. A-APs are affiliated with one AP MLD and operate on different frequency channels. Also, A-STAs are affiliated with one STA MLD and operate on different frequency channels. When A-APs or A-STAs are affiliated with an AP MLD or an STA MLD, this may be referred to as belonging to the MLD. Note that in the following embodiment, a case will be described in which multi-link communication is performed using the IEEE 802.11be standard, but the present invention is not limited to this. For example, the following discussion can also be applied to multi-link communication conforming to other wireless communication standards and multi-link communication using multiple wired links.

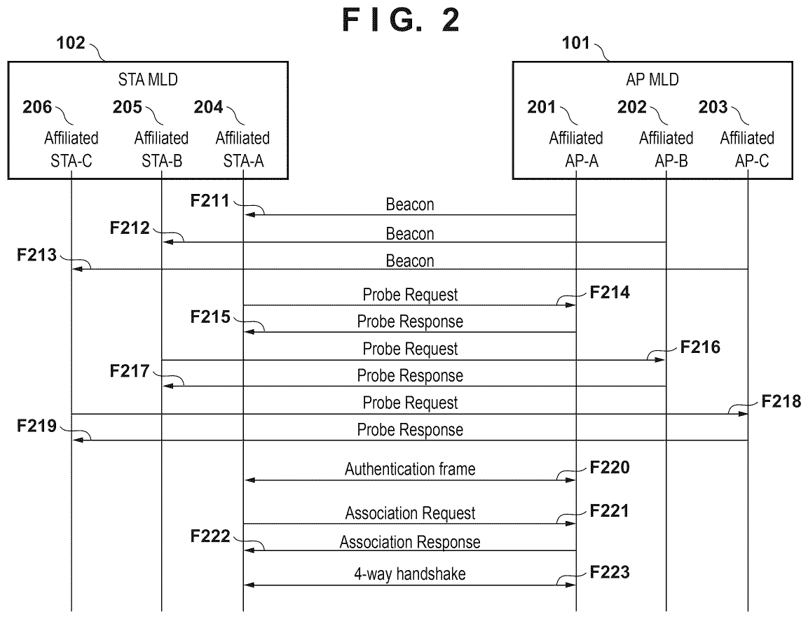

FIG. 2 shows an example of a sequence for establishing multi-link communication between the AP 101 and the STA 102. The AP 101, which is an AP MLD, has affiliated APs (A-AP)-A 201 to A-AP-C 203 as wireless I/Fs that operate on frequency channels corresponding to respective links. Also, the STA 102, which is an STA MLD, has affiliated STAs (A-STA)-A 204 to A-STA-C 206 as wireless I/Fs that operate on frequency channels corresponding to respective links. Information required to establish multi-link communication between the AP 101 and the STA 102 can be notified to each other by the Basic Multi-Link element. For example, the AP MLD transmits a Beacon or a Probe Response including the Basic Multi-Link element via each of the affiliated APs A-AP-A 201 to A-AP-C 203 (F211 to F219). Note that the Probe Response can be transmitted in response to a Probe Request transmitted from the STA 102 (F214 to F219). On the other hand, the STA MLD notifies the Basic Multi-Link element to the AP MLD by using an Association Request transmitted via the A-STA, which will be described later. The STA 102 receives the Beacon or the Probe Response via the affiliated STAs A-STA-A 204 to A-STA-C 206. The STA 102 can detect that the AP 101 is an AP MLD by checking whether or not the Basic Multi-Link element is included in the received Beacon or Probe Response. Upon detecting that the AP 101 is an AP MLD, the STA 102 acquires information about the A-APs that belong to the AP MLD from the RNR element included in the received Beacon or Probe Response. RNR is an abbreviation for Reduced Neighbor Report. Note that the RNR element can include information regarding the A-APs affiliated with the same AP MLD, as well as information regarding APs in the vicinity of the A-AP that transmits the RNR element. For example, the RNR element can include information regarding the frequency bands and the channels used by the A-APs affiliated with the same AP MLD and by surrounding APs. Note that the fact that APs reported by the RNR element are A-APs affiliated with the same AP MLD can be indicated by the value of the MLD ID associated with the AP being 0. The STA 102 can establish multi-link communication with the AP 101 using any of the A-STAs. For example, the STA 102 may execute a procedure to establish multi-link communication with the A-AP-A 201 via the A-STA-A 204. As a procedure for establishing multi-link communication, an Authentication Frame, an Association Request, and an Association Response can be exchanged with the AP 101 (F220 to F222). For example, the STA 102 can request the AP 101 to establish multi-link communication by transmitting an Association Request that includes the Basic Multi-Link element (F221). As one example, the STA MLD determines the frequency channel in which each A-STA operates based on information regarding the A-APs obtained using the RNR element. The STA MLD then uses the Basic Multi-Link element to notify the AP MLD of information such as the frequency channels on which the A-STAs operate. The AP MLD obtains information such as the frequency channels on which the A-STAs operate from the received Basic Multi-Link element. When the AP MLD returns an Association Response, multi-link communication can be established between the AP 101 and the STA 102 (F222). The STA MLD switches the operating frequency channels of the A-STAs to the determined frequency channels. This makes it possible for multiple links to be collectively established between the A-APs and the A-STAs without executing a link establishment procedure for each link individually. Note that after establishing multi-link communication, the AP 101 and the STA 102 can exchange security information and the like using a 4-way handshake procedure (F223). Note that if the AP 101 is not an AP MLD, the STA 102 can establish a connection using a single frequency channel. Usage of the Basic Multi-Link element and the RNR element is one example of a technique for exchanging information regarding multi-link communication between the AP 101 and an STA 102, but other techniques may also be used.

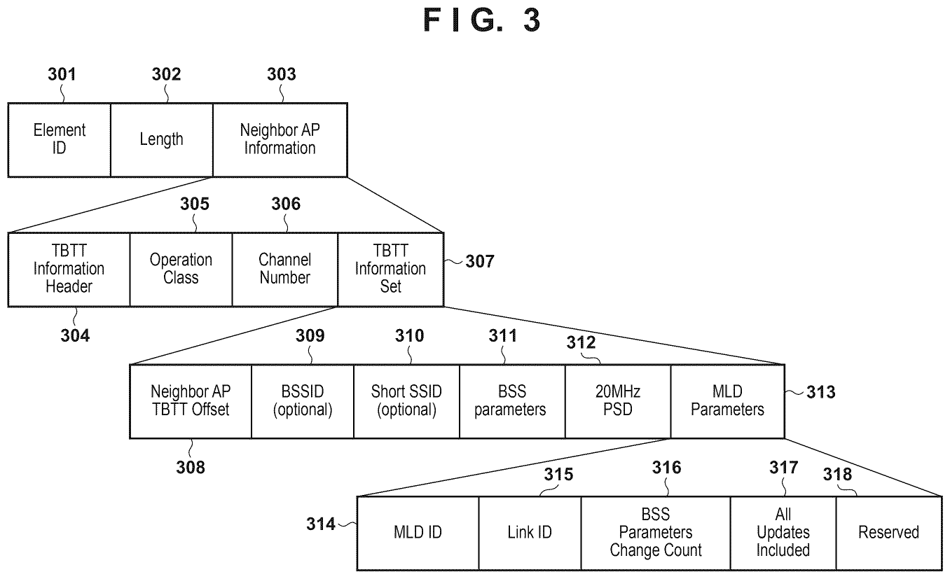

FIG. 3 shows an example of the RNR element. The RNR element can include an Element ID 301, a Length 302, and Neighbor AP Information 303. The Element ID 301 indicates the type of the element. For example, in the case of an RNR element, a value of 201 can be stored. The Length 302 indicates the length of the element. The number of pieces of Neighbor AP Information 303 can be the same as the number of the APs to be announced. Each piece of Neighbor AP Information 303 can include a TBTT Information Header 304, an Operation Class 305, and a Channel Number 306. Each piece of Neighbor AP Information 303 can also include a TBTT Information Set 307. The TBTT Information Header 304 is header information indicating the length of, for example, each piece of TBTT Information included in the TBTT Information Set 307. The Operation Class 305 is used together with the Channel Number 306 to indicate the starting frequency of the primary channel used by the AP associated with the Neighbor AP Information 303 (the AP to be reported). The TBTT Information Set 307 can include a Neighbor AP TBTT Offset 308, a BSSID 309, a Short SSID 310, BSS Parameters 311, and a 20 MHz PSD 312. The TBTT Information Set 307 can also include MLD Parameters 313. The Neighbor AP TBTT Offset 308 indicates information regarding the timing of a Beacon transmitted by the AP to be reported. The BSSID 309 indicates the identifier of the network constituted by the AP to be reported. The Short SSID 310 indicates a value obtained by applying an SSID (Service Set Identifier) to a predetermined calculation formula. The BSS Parameters 311 indicate the parameters of the network constituted by the AP to be reported. The MLD parameters 313 can include an MLD ID 314, a Link ID 315, a BSS Parameters Change Count 316, an All Updates Included 317, and a Reserved 318. The MLD ID 314 indicates the identifier of the AP MLD to which the AP to be reported is affiliated. When the AP to be reported is affiliated with the same AP MLD as the AP transmitting the RNR element, the value of the MLD ID 314 can be set to 0. The Link ID 315 indicates the link identifier of the AP to be reported. The BSS Parameters Change Count 316 indicates how long until a change in network parameters is implemented in the AP to be reported. The All Updates Included 317 is set to 1 if all updated elements were included in the most recent parameter update. The Reserved 318 is a reserved field.

One form of multi-link communication is multi-link single radio (MLSR). In general, an MLD that supports multi-link communication has multiple wireless I/Fs, with each wireless I/F corresponding to one link when executing communication using multiple links. On the other hand, in MLSR, a communication device maintains multiple links established with a partner communication device while performing communication using one link at a time. The IEEE 802.11be standard is expected to include provisions for enhanced multi-link single radio (EMLSR), which is an extension of MLSR and enables switching to a more suitable link when performing communication. For example, in EMLSR, the STA 102 performs signal detection (a Listen operation) on multiple links. The AP 101 then transmits an Initial Control Frame using one of the links on which the STA 102 is performing the Listen operation. Thereafter, data communication and the like is performed between the AP 101 and the STA 102 using the link over which the Initial Control Frame was transmitted. The Initial Control Frame can be, for example, an MU-RTS Trigger frame or a BSRP Trigger frame, but is not limited to this. Here, MU-RTS is an abbreviation for multi-user request to send. Also, BSRP is an abbreviation for buffer status report poll. The Initial Control Frame can also be transmitted from the STA 102.

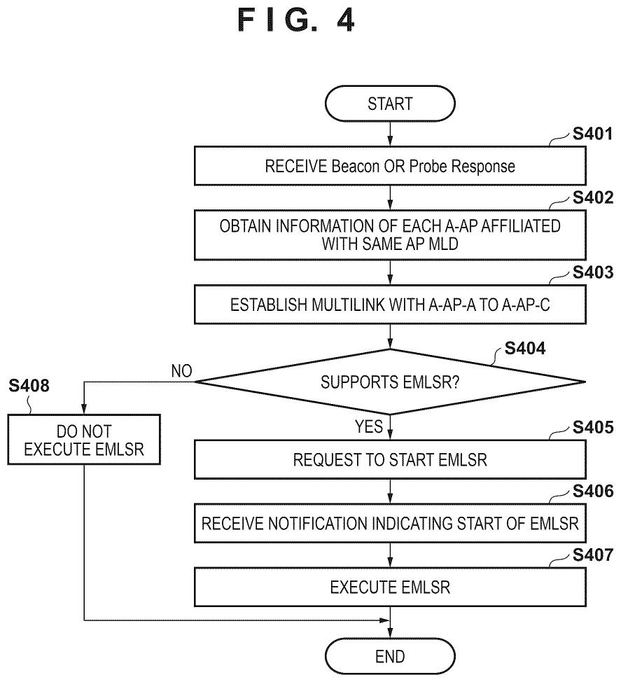

Information required for performing EMLSR between the AP 101 and the STA 102 can be notified by the Basic Multi-Link element included in a Beacon or a Probe Response transmitted from the AP MLD. For example, if the value of the EMLSR Support field in the Common Info field of the Basic Multi-Link element notified from the AP 101 is 1, this can indicate that the AP MLD supports EMLSR. FIG. 4 is an example of a flowchart EMLSR performed between the AP 101 and the STA 102. First, as described above, the STA 102 establishes multi-link communication with the AP 101 (steps S401 to S403). For example, the STA 102 receives a Beacon or a Probe Response from an A-AP (e.g., A-AP-A 201) and confirms that the AP 101 supports multi-link communication (step S401). The STA 102 obtains information regarding the A-APs that affiliated with the AP 101, which is an AP MLD, by using the RNR element (step S402). The STA 102 executes a procedure for establishing multi-link communication with the AP 101 according to, for example, F220 to F222 shown in FIG. 2. The STA 102 sets the operating frequency channels on which the A-STAs operate as the frequency channels to be used by the A-APs, and establishes multi-link communication with the AP 101 (step S403). The STA 102 then performs processing to execute EMLSR. First, the STA 102 checks the value of the EMLSR Support field in the Common Info field of the Basic Multi-Link element included in the received Beacon or Probe Response (step S404). In other words, the STA 102 checks whether the AP 101 supports EMLSR. If the EMLSR Support field is not 1, the STA 102 determines that EMLSR is not supported by the AP 101 (NO in step S404), and does not use EMLSR (step S408). On the other hand, if the EMLSR Support field is 1, the STA 102 determines that the AP 101 supports EMLSR (YES in step S404), and requests the start of EMLSR (step S405). For example, the STA 102 can transmit an EML Operating Mode Notification frame to the AP MLD. The AP 101 receives the EML Operating Mode Notification frame and then transmits a notification indicating the start of EMLSR. For example, the AP 101 can transmit an EML Operating Mode Notification having a value set the same as the value of the EML Control field of the received EML Operating Mode Notification. Upon receiving the EML Operating Mode Notification frame, the STA 102 determines that the start of EMLSR has been approved by the AP 101 (step S406), and executes EMLSR (step S407).

In general, when multi-link communication is performed, the amount of power consumed in the communication device is higher than when performing communication using one link. To address this, by using EMLSR, multiple established links are maintained while using one of the links to perform communication, thus making it possible to reduce the power consumption of the communication device. Also, in EMLSR, one link is selected from among multiple links, and therefore in a congested communication environment for example, communication performance can be improved (e.g., delay can be reduced) by appropriately selecting a link among available links. On the other hand, there are cases where communication performance is improved by performing multi-link communication. For example, in an environment where communication is not congested, by performing communication at high speed using multi-link communication, delay can be reduced and power consumption can be suppressed. In this way, although the use of EMLSR improves communication performance and power efficiency in some cases, there may also be cases where the communication performance and power efficiency are not improved due to the extra processing that is performed.

In consideration of such circumstances, in the present embodiment, the STA 102 obtains information indicating whether the AP 101 can execute communication using a predetermined communication method. If the AP 101 is capable of executing communication using a predetermined communication method and is to perform communication using the predetermined communication method, the STA 102 starts communication using the predetermined communication method based on control performed by the AP 101. For example, the predetermined communication method can be a communication method in which multiple communication links are maintained while performing communication selectively using one or more of the communication links and not using the remaining communication links. As one example, the predetermined communication method can be EMLSR, but is not limited to this, and may be any communication method in which multiple communication links are maintained while selectively using one or more of the communication links and not using the remaining communication links. For example, with EMLSR, the STA 102 can maintain multiple links while selectively using any one of the links. In the following, EMLSR will be used as an example for description. In the present embodiment, the STA 102 can itself make an execution determination regarding whether or not communication using EMLSR is to be started. Upon determining that EMLSR is to be executed when making the execution determination, the STA 102 requests the AP 101 to start performing communication using EMLSR. Also, while executing EMLSR, the STA 102 determines whether or not to continue EMLSR, and upon determining that EMLSR is not to be continued, the STA 102 makes a request to the AP 101 to terminate EMLSR. The STA 102 may terminate EMLSR based on the response from the AP 101. In this way, the STA 102 does not simply execute EMLSR based on whether or not the AP 101 supports EMLSR, but rather executes EMLSR under the control of the AP 101 when EMLSR is to be executed. On the other hand, the AP 101 of the present embodiment can make an execution determination regarding whether or not to cause the STA 102 to start communication using EMLSR. Upon determining that the STA 102 is to execute EMLSR when making the execution determination, the AP 101 instructs the STA 102 to start communication using EMLSR. The STA 102 executes EMLSR based on the execution determination made by the AP 101. Also, while executing EMLSR, the AP 101 determines whether or not EMLSR is to be continued, and upon determining that EMLSR is not to be continued, the AP 101 instructs the STA 102 to terminate EMLSR. Note that in the following, an example of operations performed by the STA 102 will be described, but similar operations can also be applied to the AP 101.

The STA 102 can determine whether or not to execute EMLSR based on the communication quality of each of multiple links between the STA 102 and the AP 101. In this case, the STA 102 can, for example, measure the communication quality of each of multiple links between the STA 102 and the AP 101, and if there are any communication links whose value indicating the communication quality is lower than a predetermined threshold value, determine whether or not to perform EMLSR based on the number of such links. As one example, the STA 102 can determine that EMLSR is to be performed if there are multiple communication links whose value indicating the communication quality is lower than the predetermined threshold value. The value indicating the communication quality may be a received signal strength indicator (RSSI) or a signal to noise ratio (SNR), or other parameters may be used. In this case, the STA 102 can calculate the RSSI and SNR using the reception power of the Beacon, the Probe Response, and the like received from the AP 101. When a link has a low communication quality, packet errors and retransmissions are likely to occur, and therefore transmission delays are highly likely to occur. If transmission delay occurs in one or more of the links used in multi-link communication, packets that have been successfully received on another link may need to be buffered for a longer period of time, which may increase the overall delay in communication. In such an environment, if EMLSR is selected, it becomes possible to avoid using a link having a low communication quality, and therefore the communication performance of multi-link communication can be improved. Note that the STA 102 may use the utilization rate of the frequency channel used by a link as the value indicating the communication quality. For example, the STA 102 measures the proportion of time during which the reception power is above a predetermined threshold value in each frequency channel per unit time. Then, if there are multiple frequency channels whose ratio is above a predetermined threshold value, it can be determined that EMLSR is to be performed. In a situation where a frequency channel has a high utilization rate and is congested, there is a high likelihood that the communication device will experience increased delay in obtaining an opportunity to transmit. In such an environment, if EMLSR is selected, it is possible to avoid using a link that results in an increase in delay, thereby making it possible to improve the communication performance of multi-link communication.

The STA 102 may determine whether or not to execute EMLSR based on information obtained or notified from other communication devices. For example, the STA 102 can count the number of devices on the frequency channels used by the links with the AP 101, and determine whether or not to execute EMLSR based on the number. As one example, the STA 102 can obtain the number of the APs operating on each frequency channel from the RNR element or the like included in Beacons or Probe Responses received on the frequency channels used by the links. In this case, the STA 102 specifies the number of frequency channels on which the number of operating APs is above a predetermined threshold value. The STA 102 can then determine to execute EMLSR if the number of frequency channels is above a predetermined threshold value. When a large number of APs are operating in a particular frequency channel, the percentage of the frequency channel used by devices other than the AP 101 and the STA 102 can possibly be large, and transmission delays are likely to occur. As mentioned above, an increase in the transmission delay of one or more of the links used in multi-link communication may increase the overall delay in communication, and therefore the communication performance of multi-link communication can be improved by selecting EMLSR in such an environment. Note that instead of counting the number of devices on each frequency channel, the STA 102 may determine whether or not to execute EMLSR based on an indicator indicating the congestion of the frequency channel, which is notified by the AP 101. For example, the STA 102 can use the BSS Load element, the Extended BSS Load element, or the like included in the Beacon or the Probe Response as an indicator. In this case, the STA 102 can use the traffic load, the number of connected devices, and the like in the network configured by the APs as an indicator.

The STA 102 may determine whether or not to execute EMLSR based on its own device state. For example, the STA 102 can determine to execute EMLSR if the remaining battery amount of the device is less than or equal to a predetermined threshold value, or is lower than the predetermined threshold value. When multiple wireless I/Fs corresponding to multiple links are all in operation, the power consumption in the STA 102 becomes relatively high. When the remaining battery amount is low, executing EMLSR can slow down the rate at which the battery amount decreases. Also, in such a case, the STA 102 may select a link to be used based on the communication quality of the links, rather than using one link in a fixed manner. This makes it possible to reduce power consumption while also preventing degradation of communication quality. Also, the STA 102 can determine to execute EMLSR if the STA 102 is in a power saving operation mode that consumes less power than during normal operation. For example, the power saving operation mode can be the Power Save operation mode defined in the IEEE 802.11 standard series. The STA 102 can determine to execute EMLSR if, among the links used in the multi-link communication, the number of links on which the power saving operation mode is being executed is above a predetermined threshold value. Also, the STA 102 may determine to execute EMLSR if the terminal device in which the STA 102 is implemented is operating in the power saving operation mode. For example, the Operating System of the terminal device may operate in the power saving operation mode upon detecting that the remaining battery amount is low. The STA 102 can determine to execute EMLSR based on the operation of the Operating System of the terminal device.

The STA 102 can determine whether or not to execute EMLSR based on the type of application that is performing communication. For example, the STA 102 can determine to execute EMLSR if the application performing communication requires low-latency communication (e.g., real-time communication, a printer job, autonomous driving, or control of drones or robots). By using EMLSR to avoid the use of congested links while performing communication, it becomes possible to avoid the occurrence of large delays. On the other hand, if the application performing communication requires large-volume communication (e.g., high-definition video distribution), the STA 102 can determine not to execute EMLSR. By performing communication using more links, including links with low communication quality, data transfer can be completed more quickly. In such cases, the STA 102 can determine that EMLSR is to be executed by, for example, detecting the start of communication of a predetermined traffic type based on, for example, the traffic type (Traffic Identifier) of the data being communicated with the AP 101.

The STA 102 can determine whether or not to execute EMLSR based on a received instruction. For example, the STA 102 can determine to execute EMLSR if a setting from a user indicates that EMLSR is to be executed. In this case, the STA 102 can determine whether or not EMLSR is to be executed when multi-link communication with the AP 101 is established, or by periodically checking a setting of the device made by the user, for example. Furthermore, the STA 102 can determine to execute EMLSR when an instruction that EMLSR is to be executed is received from the AP 101. For example, the STA 102 can determine that EMLSR is to be executed upon receiving an EML Operating Mode Notification frame. By executing EMLSR based on an instruction from the AP 101, it becomes possible to determine whether or not to execute EMLSR based on information that cannot be obtained simply by measurement of the vicinity of the STA 102 or by notification from the AP 101 alone.

### Device Configuration

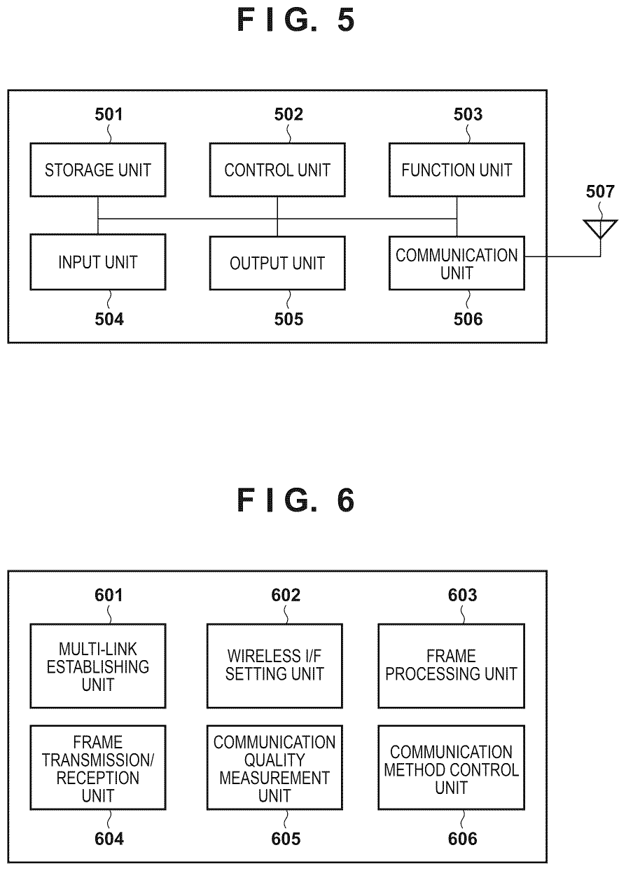

FIG. 5 shows an example of the hardware configuration of the AP 101 and the STA 102 in the present embodiment. The AP 101 includes a storage unit 501, a control unit 502, a function unit 503, an input unit 504, an output unit 505, a communication unit 506, and an antenna 507. Note that there may be multiple antennas. The storage unit 501 is configured by one or more memory such as a ROM, a RAM, or the like, and stores various information such as computer programs for performing various operations described below and communication parameters for wireless communication. ROM and RAM are abbreviations for read only memory and random access memory, respectively. Note that besides a memory such as ROM or RAM, the storage unit 501 may also be constituted using a storage medium such as a flexible disk, a hard disk, an optical disk, a magneto-optical disk, a CD-ROM, a CD-R, a magnetic tape, a non-volatile memory card, or a DVD. Furthermore, the storage unit 501 may include multiple memories, for example. Note that the storage unit 501 can record setting information input by a user to the device, information regarding a state of the device, such as the remaining amount of the battery included in the device, and whether or not a power saving operation mode has been set.

The control unit 502 is configured by one or more processor, such as a CPU or an MPU, and performs overall control of the AP 101 or the STA 102 by executing a computer program stored in the storage unit 501. The control unit 502 may perform overall control of the AP 101 or the STA 102 by cooperation between a computer program stored in the storage unit 501 and an operating system (OS). Also, the control unit 502 generates data and signals (wireless frames) to be transmitted in communication with other communication devices. Note that CPU is an abbreviation for central processing unit and MPU is an abbreviation for micro processing unit. Furthermore, the control unit 502 may include multiple processors such as multi-core processors, and overall control of the AP 101 or the STA 102 may be performed by multiple processors. Also, the control unit 502 controls the function unit 503 to execute predetermined processing such as wireless communication, image capturing, printing, and projection. The function unit 503 is hardware that enables the AP 101 or the STA 102 to execute predetermined processing.

The input unit 504 accepts various operations from the user. The output unit 505 outputs various types of information to the user via a monitor screen and a speaker. Here, the output performed by the output unit 505 may be a display on the monitor screen, sound output from the speaker, vibration output, or the like. Note that both the input unit 504 and the output unit 505 may be realized by a single module such as a touch panel. Furthermore, the input unit 504 and the output unit 505 may be integrated with the AP 101 or the STA 102, or may be separate.

The communication unit 506 controls wireless communication conforming to the IEEE 802.11be standard. Furthermore, the communication unit 506 may control wireless communication compliant with other IEEE 802.11 series standards in addition to the IEEE 802.11be standard, and may control wired communication over a wired LAN or the like. The communication unit 506 controls the antenna 507 to transmit and receive signals generated by the control unit 502 for wireless communication. The communication unit 506 may be configured by multiple communication circuits respectively corresponding to the links. Note that if the AP 101 supports the NFC standard, the Bluetooth standard, or the like in addition to the IEEE 802.11be standard, the AP 101 may control wireless communication in accordance with such communication standards. Furthermore, if the AP 101 can execute wireless communication conforming to multiple communication standards, the AP 101 may be configured to have a separate communication unit and antenna for each communication standard. The communication device performs communication of data such as image data, document data, and video data with another communication device via the communication unit 506. Note that the antenna 507 may be configured as a separate unit from the communication unit 506, or may be configured together with the communication unit 506 as a single module.

The antenna 507 is an antenna capable of communication in the 2.4 GHz band, the 5 GHz band, the 6 GHz band, and the like. In the present embodiment, there may be two or more antennas, and when the communication unit 506 is configured by multiple communication units, a separate antenna may be provided for each communication unit. Also, a different antenna may be provided for each frequency band.

FIG. 6 is a block diagram showing the functional configuration of the communication devices (the AP 101 and the STA 102) of the present embodiment. The communication device can include a multi-link establishing unit 601, a wireless I/F setting unit 602, a frame processing unit 603, a frame transmission/reception unit 604, a communication quality measurement unit 605, and a communication method control unit 606. The multi-link establishing unit 601 controls communication start processing for establishing one or more links to be used by the communication device for wireless communication with a partner communication device, control processing for controlling functions related to multi-link communication, addition processing and deletion processing for adding and deleting links after communication has started, and communication end processing for deleting all links. For example, connection processing can be made up of authentication processing, association processing, and 4-way hand shake (4WHS) processing. The wireless I/F setting unit 602 performs communication setting for each link. For example, the wireless I/F setting unit 602 of the STA 102 selects and determines the A-AP to which each A-STA is to be connected, sets the frequency channel to be used by each A-STA, and so on. Furthermore, the wireless I/F setting unit 602 of the AP 101 sets information regarding the A-STA connected to each A-AP. Furthermore, the wireless I/F setting unit 602 of the AP 101 notifies the frame processing unit 603 and the frame transmission/reception unit 604 of information regarding the A-APs and the A-STAs with which links are to be established. The frame processing unit 603 generates frames to be transmitted in accordance with the setting performed by the wireless I/F setting unit 602. For example, the frame processing unit 603 of the AP 101 generates a Beacon and a Probe Response that includes the Basic Multi-Link element and the RNR element, and the like. Furthermore, the frame processing unit 603 of the AP 101 generates frames such as an Authentication frame, an Association Response frame, and an EML Operating Mode Notification frame. The frame processing unit 603 of the STA 102 generates, for example, an Association Request and a Probe Request that includes the Basic Multi-Link element and the RNR element. Also, the frame processing unit 603 of the STA 102 generates an EML Operating Mode Notification frame. Furthermore, the frame processing unit 603 processes frames received from a partner communication device and acquires information. For example, the frame processing unit 603 of the STA 102 acquires information indicating that the AP 101 can execute multi-link communication and EMLSR from the Basic Multi-Link element and the RNR element included in a received Beacon or the like. Furthermore, the frame processing unit 603 of the STA 102 acquires the number of devices on the frequency channels used in multi-link communication. In accordance with an instruction from the wireless I/F setting unit 602, the frame transmission/reception unit 604 transmits wireless frames, including data frames and Beacon and Probe Response frames generated by the frame processing unit 603, and receives wireless frames from a partner device. For example, the frame transmission/reception unit 604 of the AP 101 can notify the STA 102 that EMLSR is to be started by transmitting an EML Operating Mode Notification frame. The communication quality measurement unit 605 measures and calculates communication quality using Beacon or Probe Response frames received by the frame transmission/reception unit 604. Note that examples of the communication quality information include, but are not limited to, RSSI and SNR. The communication method control unit 606 determines whether or not EMLSR is to be executed or continued based on, for example, the results of measurement and calculation of communication quality by the communication quality measurement unit 605, information acquired by the frame processing unit 603, settings and power information of the device recorded in the storage unit 501, and the like.

### PROCESSING FLOW

Next, flows of processing executed by the AP 101 and the STA 102 described above, sequences in the wireless communication system, and the like will be described using several embodiments.

### Processing Example 1

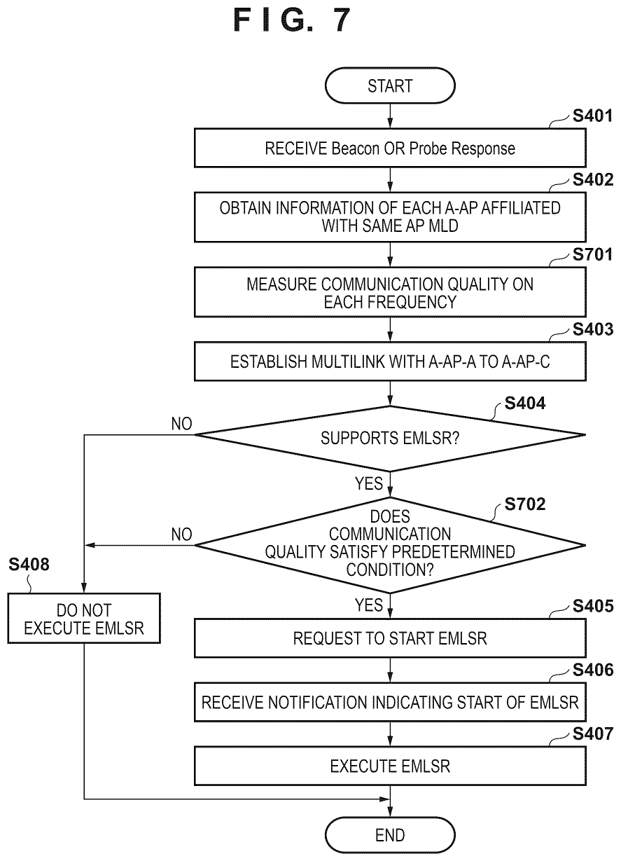

FIG. 7 shows an example of processing in which the STA 102 determines whether or not to execute EMLSR based on the communication quality of links in multi-link communication established with the AP 101. Note that in FIG. 7, operations similar to those in FIG. 4 are denoted by the same reference numerals, and detailed description thereof will be omitted. This processing can be started when, for example, the STA 102 connects to the AP 101. Furthermore, if the communication quality of communication between the STA 102 and the currently connected AP 101 deteriorates, the STA 102 can start this processing upon detecting another AP 101 that can be the next connection destination.

First, the STA 102 receives a Beacon or a Probe Response via one of the A-STAs (step S401). At this time, the STA 102 confirms that the AP 101 is an AP MLD by confirming that the received Beacon or Probe Response includes the Basic Multi-Link element. The STA 102 then acquires information such as the frequency band and the frequency channel of each A-AP affiliated with the AP 101, which is an AP MLD, based on the Basic Multi-Link element and the RNR element (step S402). For example, if a Beacon transmitted by the A-AP-A 201 is received via the A-STA-A 204, the STA 102 can obtain information regarding the A-AP-B 202 and the A-AP-C 203 from the Basic Multi-Link element or the like. The STA 102 measures the communication quality on each frequency channel (step S701). For example, the STA 102 can measure the communication quality with the A-AP-A 201 by measuring the RSSI, SNR, or the like of the Beacon received via the A-STA-A 204. The STA 102 then sets the A-STA-B 205 and the A-STA-C 206 to the frequency channels used by the A-AP-B 202 and the A-AP-C 203, and receives Beacons and Probe Responses received on the frequency channels. The STA 102 can measure the communication quality with the A-AP-B 202 and the A-AP-C 203 using the RSSI or the like of the received Beacons or the like. The STA 102 then establishes multi-link communication with the AP 101 (step S403).

The STA 102 determines whether or not the AP 101 supports EMLSR (step S404), and if EMLSR is not supported (NO in step S404), determines not to execute EMLSR (step S408). On the other hand, if the AP 101 supports EMLSR (YES in step S404), the STA 102 determines whether or not the communication quality with the AP 101 satisfies a predetermined condition (step S702). For example, the STA 102 specifies the communication quality of the links based on the RSSI of Beacons or the like received from the A-APs, and determines whether or not a predetermined condition is satisfied. As one example, first, the STA 102 determines whether or not the measured RSSI is greater than the minimum reception power required to use the modulation and coding scheme (MCS) with the lowest transmission rate on each link. For example, the STA 102 can set the predetermined condition to the condition that the number of links whose measured RSSI is lower than the minimum reception power is greater than or equal to a predetermined threshold value. Note that the MCS is an index of combinations of wireless modulation schemes, coding rates, and the like, and the MCS that a communication device can use varies depending on the communication environment. For example, it is possible to use an MCS with a lower transmission rate the worse the communication quality is. In this example, the STA 102 can compare the measured RSSI for each link with the minimum reception power and specify the number of links whose RSSI is below the minimum reception power. For example, if the RSSI is below the minimum reception power for multiple (e.g., two or more) links, the STA 102 can determine that the communication quality will be improved by using EMLSR. In this case, the STA 102 performs a procedure to execute EMLSR with the AP 101 (steps S405 to S407). Note that the STA 102 may determine to use EMLSR when the RSSI is below the minimum reception power in three or more links. Also, the STA 102 may determine whether or not to use EMLSR based on the ratio of the number of links on which the RSSI is below the minimum reception power to the number of links established with the AP 101. On the other hand, if the predetermined condition is not satisfied (NO in step S702), the STA 102 determines not to execute EMLSR (step S408). For example, if the RSSI is greater than the minimum reception power for any link, the STA 102 can determine that the predetermined condition is not satisfied. Note that the threshold value used as the predetermined condition is not limited to the minimum reception power, and may be the reception power required to use a predetermined MCS. Also, if the RSSI is below the minimum reception power for one link, the STA 102 may determine that the predetermined condition is satisfied. In this way, if the communication quality of one or more links between the AP 101 and the STA 102 satisfies a predetermined condition, by executing EMLSR, it becomes possible to select a link from among links with good quality for communication. This makes it possible to improve communication performance when using EMLSR.

Upon receiving a response to the request to start EMLSR from the AP 101, the STA 102 starts communication using EMLSR. Here, while executing EMLSR, the STA 102 can select the link with the best communication quality from among the maintained links and execute communication using the selected link. For example, while maintaining the links, the STA 102 measures the communication quality of the frequency channel used by each link. The STA 102 may periodically measure the communication quality using a Beacon or the like received from the AP 101, or may measure the communication quality using a frame exchanged with the AP 101 prior to transmission. The STA 102 may update the link used in EMLSR each time the communication quality is measured. Furthermore, the STA 102 can use a random number or the like to select a link whose communication quality is above a predetermined threshold value from among multiple links, and execute communication using the selected link. Furthermore, the STA 102 can select a predetermined number of links in descending order of communication quality from among multiple links, and select one of the selected links to execute communication. In this way, while executing EMLSR, the STA 102 can select a link with good communication quality from among multiple maintained links and perform communication using the selected link, thereby improving communication performance when using EMLSR.

Note that while executing EMLSR, the STA 102 can measure the communication quality of each link, and can terminate EMLSR when a predetermined condition is satisfied. In this case, after terminating EMLSR, the STA 102 can execute multi-link communication using multiple links in parallel. As one example, the STA 102 can determine to terminate EMLSR if a predetermined condition used in executing EMLSR is not satisfied. For example, the STA 102 measures the RSSI or the SNR of a Beacon or a Probe Response received from the A-AP on each link. It is then determined whether or not the RSSI or the like of the link is above the minimum reception power. For example, if the predetermined condition for executing EMLSR is that the RSSI is below the minimum reception power for two or more links, the STA 102 can determine to terminate EMLSR when there are not two or more links whose RSSI is below the minimum reception power. Also, the STA 102 may determine whether or not to continue EMLSR using a condition different from the predetermined condition used when executing EMLSR. For example, if the predetermined condition for executing EMLSR is that the RSSI is below the minimum reception power for two or more links, the STA 102 can determine to terminate EMLSR when the RSSI is above the minimum reception power for all links. In this way, if the communication quality of links between the AP 101 and the STA 102 satisfies a predetermined condition while EMLSR is being executed, EMLSR can be terminated, thus making it possible to perform communicate using multiple links with good quality in parallel. This makes it possible to improve the communication performance between the AP 101 and the STA 102.

### Processing Example 2

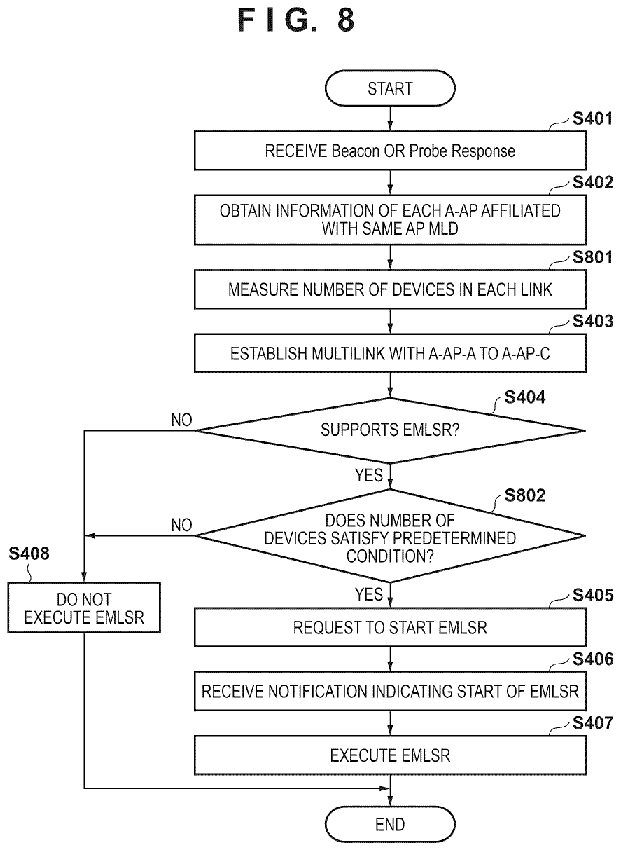

FIG. 8 shows an example of processing in which the STA 102 determines whether or not to execute EMLSR based on information obtained from or notified from other communication devices. Note that in FIG. 8, operations similar to those in FIG. 4 or FIG. 7 are denoted by the same reference numerals, and detailed description thereof will be omitted. For example, the STA 102 obtains information regarding the A-APs affiliated with the AP 101, which is an AP MLD, from Beacons or Probe Responses transmitted by the AP 101, and establishes multi-link communication with the AP 101 (steps S401, S402, and S403). At this time, the STA 102 obtains information regarding the A-APs affiliated with the AP 101, which is an AP MLD, and other surrounding APs, using the RNR element or the Basic Multi-Link element included in the Beacons or the like transmitted from the AP 101. For example, the STA 102 can use the RNR element or the Basic Multi-Link element to specify the frequency channel on which each A-AP included in the AP 101 operates and obtain information regarding other APs that use that frequency channel. The STA 102 then calculates the number of devices operating on each of the frequency channels on which the A-APs operate (step S801). For example, in the Basic Multi-Link element, the same MLD ID is assigned to each A-AP that constitutes the same AP MLD. Therefore, for example, the STA 102 can calculate the number of the APs on the frequency channels on which the A-APs operate by counting the number of different MLD IDs included in the Basic Multi-Link element for each frequency channel. Furthermore, the STA 102 may calculate the number of the APs on each frequency channel using the included A-STAs. For example, the STA 102 specifies the frequency channel on which each A-AP included in the AP 101 operates by using the RNR element or the Basic Multi-Link element. The STA 102 then receives Beacons and Probe Responses transmitted by other APs on each frequency channel. For example, the STA 102 can receive Beacons and Probe Responses on each frequency channel by setting the included A-STAs to the frequency channels on which the A-APs operate. The STA 102 can calculate the number of the APs operating on each frequency channel using the AP identifiers or RNR elements included in the received Beacons and Probe Responses. Note that the number of devices that the STA 102 counts as devices operating on each frequency channel are not limited to APs, and may include the number of STAs connected to each AP and communication devices of other wireless systems. For example, the STA 102 may obtain and use the number of the STAs connected to each AP by using the BSS Load, the Extended BSS Load, or the like included in the Beacon or Probe Response. Additionally, the information that the STA 102 can obtain and use from other communication devices is not limited to the number of operating devices. For example, the STA 102 may obtain and use the utilization rate of a frequency channel, or the like. The STA 102 can obtain the utilization rate of a frequency channel using the BSS Load, the Extended BSS Load, or the like included in a Beacon or a Probe Response.

Upon establishing multi-link communication with the AP 101, the STA 102 determines whether or not the AP 101 supports EMLSR (step S404), and determines whether or not a predetermined condition is satisfied based on the information obtained in step S801 (step S802). For example, the STA 102 determines whether or not the numbers of devices on the frequency channels used for the multilink satisfy a predetermined condition (step S802). For example, the STA 102 uses the number of APs on each frequency channel calculated in step S801 to specify the number of frequency channels in which the number of APs is above a predetermined threshold value. Also, instead of or in addition to the number of APs, the STA 102 may use the number of STAs connected to the APs to specify the number of frequency channels for which the number of devices operating on the frequency channel is above a predetermined threshold value. Alternatively, instead of the number of devices, the STA 102 may specify the number of frequency channels whose utilization rate is above a predetermined threshold value. If the number of frequency channels is above the predetermined threshold value, the STA 102 determines that the predetermined condition is satisfied, and determines to execute EMLSR. For example, if the number of APs is above a predetermined threshold value in multiple (e.g., two or more) frequency channels, the STA 102 can determine that communication performance will be improved by using EMLSR. Note that the STA 102 may determine to use EMLSR if the number of APs is above a predetermined threshold value in one or three or more frequency channels. In the case of determining that the predetermined condition is satisfied (YES in step S802), the STA 102 executes the processing of steps S405 to S407 and starts EMLSR. On the other hand, in the case of determining that the predetermined condition is not satisfied (NO in step S802), the STA 102 does not execute EMLSR (step S408). By determining whether or not to execute EMLSR based on the congestion of frequency channels used in multi-link communication between the AP 101 and the STA 102, it becomes possible to select a link from among links having a short delay for communication. This makes it possible to improve the communication performance between the AP 101 and the STA 102.

Upon receiving a response to the request to start EMLSR from the AP 101, the STA 102 starts communication using EMLSR. Here, while executing EMLSR, the STA 102 can select one link from among multiple links based on information obtained from or notified from other communication devices, and execute communication. For example, while maintaining each link, the STA 102 measures congestion on the frequency channel used by the link based on information obtained from or notified from other communication devices. For example, the STA 102 may obtain the number of APs, STAs, or the like operating on each frequency channel by using Beacons or the like received from the AP 101, and may obtain the utilization rates of the frequency channels. The STA 102 may then select one link from among the links based on the obtained information. For example, the STA 102 can select the link with the least number of devices operating on the frequency channel being used. The STA 102 may update the links used in EMLSR each time information is obtained from other communication devices. Furthermore, the STA 102 can use a random number or the like to select one link from among links in which the number of operating devices or the utilization rate of the frequency channel is lower than a predetermined threshold value, and execute communication using the selected link. Furthermore, the STA 102 can select a predetermined number of links in descending order of the number of operating devices or the utilization rate of the frequency channel, and select one of the links to execute communication. In this way, the STA 102 can select a less congested link based on information obtained from or notified from other communication devices and execute EMLSR, thereby improving communication performance when using EMLSR.

Note that while executing EMLSR, the STA 102 can terminate EMLSR if a predetermined condition that is based on information obtained or notified from other communication devices is satisfied. For example, the STA 102 can calculate the number of devices or the utilization rate of the frequency channel used by each link, and terminate EMLSR when a predetermined condition is satisfied. In this case, after terminating EMLSR, the STA 102 can execute multi-link communication using multiple links in parallel. For example, the STA 102 specifies the number of devices using the Beacons or Probe Responses received from the A-APs on each link. The STA 102 may specify the number of devices on each frequency using the included A-STA. It is then determined whether or not the number of devices is above a predetermined threshold value for each frequency. As one example, the STA 102 can determine to terminate EMLSR if a predetermined condition used in executing EMLSR is not satisfied. For example, if the predetermined condition is that the number of APs is above a predetermined threshold value for two or more links while executing EMLSR, the STA 102 can determine to terminate EMLSR when there are not two or more links in which the number of APs is above the predetermined threshold value. Also, the STA 102 may determine whether or not to continue EMLSR using a condition different from the predetermined condition used when executing EMLSR. For example, if the predetermined condition is that the number of APs is above a predetermined threshold value for two or more links while executing EMLSR, the STA 102 can determine to terminate EMLSR when the number of APs is below the predetermined threshold value for all links. In this way, if another STA 102 terminates EMLSR when a predetermined condition that is based on information obtained or notified from other communication devices is satisfied, communication can be performed using multiple links with low congestion in parallel. This makes it possible to improve the communication performance between the AP 101 and the STA 102.

### Processing Example 3

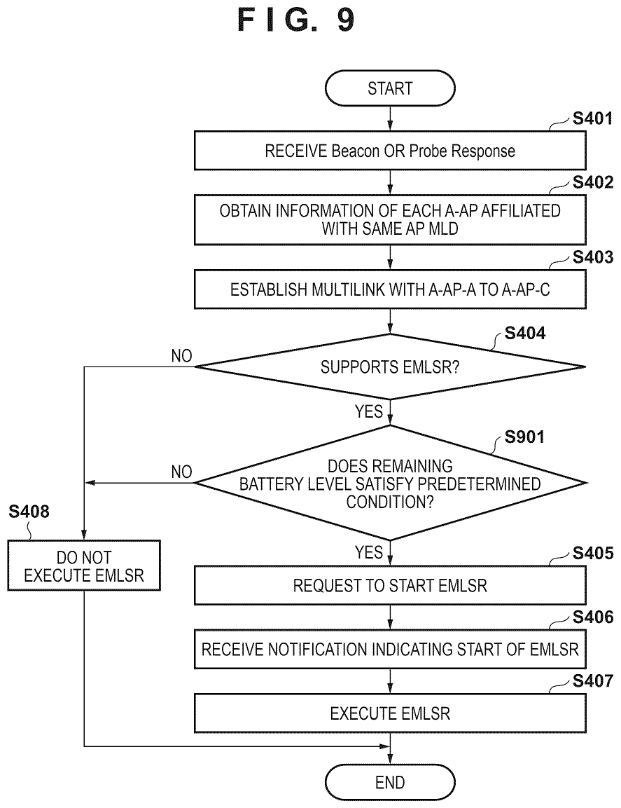

FIG. 9 shows an example of processing in which the STA 102 determines whether or not to execute EMLSR based on a self-device state. Note that in FIG. 9, operations similar to those in FIGS. 4, 7, and 8 are denoted by the same reference numerals, and detailed description thereof will be omitted. For example, the STA 102 obtains information regarding the A-APs affiliated with the AP 101, which is an AP MLD, from Beacons or Probe Responses transmitted by the AP 101, and establishes multi-link communication with the AP 101 (steps S401, S402, and S403). Upon establishing multi-link communication with the AP 101, the STA 102 determines whether or not the AP 101 supports EMLSR (step S404) and checks a self-device state (step S901). For example, the STA 102 determines whether or not the remaining battery amount is below a threshold value. If the remaining battery amount is below the threshold value, the STA 102 determines that a predetermined condition is satisfied (YES in step S901), executes the processing of steps S405 to S407, and starts EMLSR. On the other hand, in the case of determining that the predetermined condition is not satisfied (NO in step S901), the STA 102 does not execute EMLSR (step S408). Note that in step S901, instead of checking the remaining battery amount, the STA 102 may, for example, determine whether or not operation is being performed in a power saving operation mode, determine whether or not the execution of EMLSR has been set by the user, or determine the type of application performing communication, the amount of communication, or the like. In this way, by determining whether or not to execute EMLSR based on a state of the STA 102, it becomes possible to switch between multi-link communication, which uses multiple links in parallel, and EMLSR, which uses a single link, when performing communication. This makes it possible to reduce the power consumption of the device while also maintaining the communication performance when using EMLSR.

Note that while executing EMLSR, the STA 102 can monitor a self-device state and terminate EMLSR when a predetermined condition is satisfied. In this case, after terminating EMLSR, the STA 102 can execute multi-link communication using multiple links in parallel. For example, if the remaining battery amount of the device is above a predetermined threshold value, if the device transitioned from power saving operation to normal operation, or if EMLSR setting was canceled by the user, the STA 102 can determine that the predetermined condition was satisfied and terminate EMLSR. Also, if the type or amount of traffic caused by an application performing communication with the AP 101 changes, the STA 102 can determine that the predetermined condition is satisfied and terminate EMLSR. In this way, if the STA 102 terminates EMLSR when a predetermined condition associated with the self-device state is satisfied while executing EMLSR, it becomes possible to switch between EMLSR and multi-link communication, which uses multiple links in parallel, in accordance with the self-device state. This makes it possible to improve communication performance and power performance when the STA 102 performs multi-link communication.

Note that while executing EMLSR, the STA 102 can use the technique illustrated in Processing Example 1 to select the link with the best communication quality from among multiple maintained links and execute communication using the selected link. Also, while executing EMLSR, the STA 102 can use the technique illustrated in Processing Example 2 to select one link from among multiple links based on information obtained from or notified from other communication devices and execute communication using the selected link.

### Processing Example 4

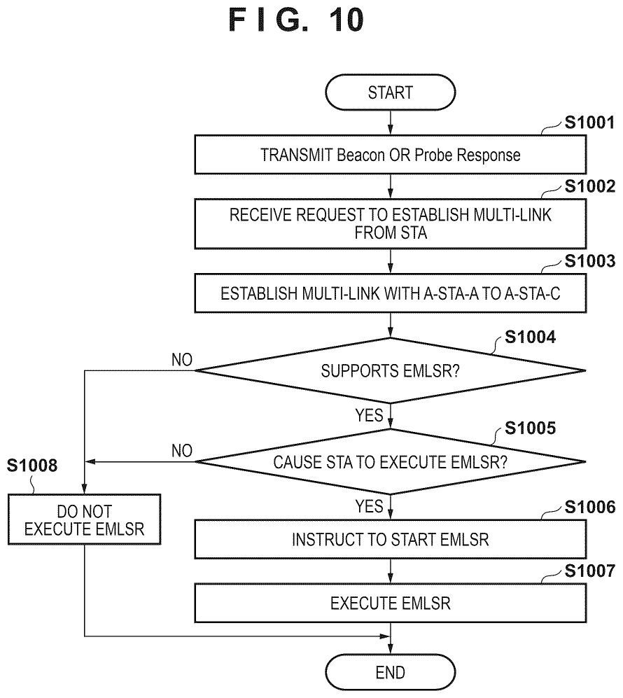

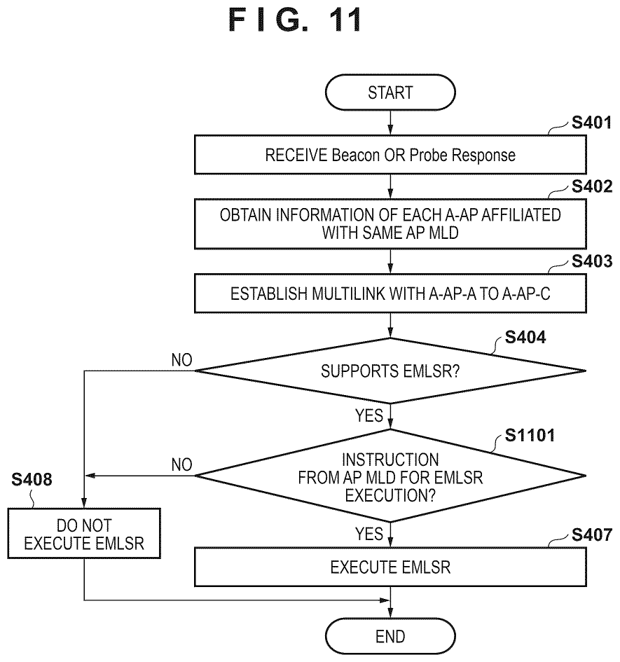

FIGS. 10 and 11 show an example of processing when the STA 102 executes EMLSR based on an instruction received from the AP 101. FIG. 10 shows the operation of the AP 101 in this processing. First, the AP 101 transmits a Beacon or a Probe Response via each of the included A-APs (step S1001). The AP 101 can notify that multi-link communication is supported by including the Basic Multi-Link element in the Beacon or the Probe Response. Also, the AP 101 can notify information regarding the included A-APs and surrounding APs using the Basic Multi-Link element or the RNR element. The AP 101 can then receive a request to establish multi-link communication from the STA 102 (step S1002). For example, a request to establish multi-link communication from the STA 102 can be made by an Association Request that includes the Basic Multi-Link element. In response to the request to establish multi-link communication from the STA 102, the AP 101 can establish multi-link communication with the STA 102 (step S1003). For example, the AP 101 can establish multi-link communication by sending an Association Response that includes the Basic Multi-Link element. Note that the AP 101 can establish association between the A-APs of the AP 101 and the A-STAs of the STA 102 by exchanging an Association Request and an Association Response. In other words, it is possible to determine the combination of A-APs and A-STAs that constitute the links used in multi-link communication. The AP 101 then determines whether or not the STA 102 supports EMLSR (step S1004). For example, the AP 101 can determine whether or not the STA 102 supports EMLSR based on the EMLSR Support value in the Basic Multi-Link element included in the Association Request received from the STA 102. If the STA 102 supports EMLSR (YES in step S1004), the AP 101 determines whether or not to cause the STA 102 to execute EMLSR (step S1005). For example, when determining whether or not to cause the STA 102 to execute EMLSR, the AP 101 can use the predetermined condition for determining whether or not the STA 102 is to execute EMLSR described above in Processing Examples 1 to 3. Specifically, the AP 101 can determine whether or not to cause the STA 102 to execute EMLSR based on information such as the communication quality between the AP 101 and the STA 102, or the number of devices operating, the utilization rate, or the like of each frequency channel used in multi-link communication. As one example, the AP 101 can determine that EMLSR is to be executed if, among the communication links established with the STA 102, there are two or more communication links whose value indicating communication quality (RSSI, SNR, etc.) is lower than a predetermined threshold value. The AP 101 may also estimate the number of devices operating on each of the frequency channels corresponding to the communication links established with the STA 102. The AP 101 can determine that EMLSR is to be executed if there are two or more frequency channels in which the estimated number of devices is above a predetermined threshold value. Note that the AP 101 may obtain the battery state, the power saving operation state, a user setting, or the like of the STA 102 and make a determination based on the obtained information. Such information can be obtained by the AP 101 requesting a report from the STA 102 and receiving the report from the STA 102. The AP 101 may also make the determination based on the type of application performing communication with the STA 102. Upon determining that the STA 102 is to execute EMLSR (YES in step S1005), the AP 101 instructs the STA 102 to start EMLSR (step S1006). For example, the AP 101 can instruct the STA 102 using an EML Operating Mode Notification. The AP 101 then executes communication with the STA 102 using EMLSR (step S1007). The AP 101 may execute EMLSR upon receiving an EML Operating Mode Notification with the same value as the EML Control field of the transmitted EML Operating Mode Notification. Note that upon determining that the STA 102 does not support EMLSR (NO in step S1004) or that the STA 102 is not to be caused to execute EMLSR (NO in step S1005), the AP 101 does not cause the STA 102 to execute EMLSR (step S1008).

Note that while executing EMLSR, the AP 101 can measure the communication quality of each link or the number of devices operating, the utilization rate, or the like of each frequency channel used in multi-link communication, and terminate EMLSR when a predetermined condition is satisfied. Also, the AP 101 can terminate EMLSR based on a state of the STA 102 obtained from the STA 102 (remaining battery amount, power saving operation status, user setting, type of application performing communication, etc.). In this case, the AP 101 can notify the STA 102 of an instruction to terminate EMLSR. For example, the AP 101 can use the EML Operating Mode Notification to notify the STA 102 of an instruction to terminate EMLSR. After terminating EMLSR, the AP 101 can execute multi-link communication using multiple links in parallel. As one example, the AP 101 can determine to terminate EMLSR if a predetermined condition used when executing EMLSR is not satisfied. Also, the AP 101 may determine whether or not to continue EMLSR using a condition different from the predetermined condition used when executing EMLSR. When determining whether or not to cause the STA 102 to continue EMLSR, the AP 101 can use the predetermined condition for determining whether or not the STA 102 is to continue EMLSR described above in Processing Examples 1 to 3. In this way, while executing EMLSR, the AP 101 determines whether or not to cause the STA 102 to continue EMLSR, and terminates EMLSR if the predetermined condition is satisfied, thereby making it possible to improve communication performance between the AP 101 and the STA 102.

Note that similarly to the operation of the STA 101 shown in Processing Example 1, the AP 101 can select the link with the best communication quality from among the maintained links during execution of EMLSR, and execute communication using the selected link. Also, similarly to the operation of the STA 101 shown in Processing Example 2, while executing EMLSR, the AP 101 can select one link from multiple links based on the number of devices operating, the utilization rate, or the like, for each frequency channel used in multi-link communication, and execute communication using the selected link.

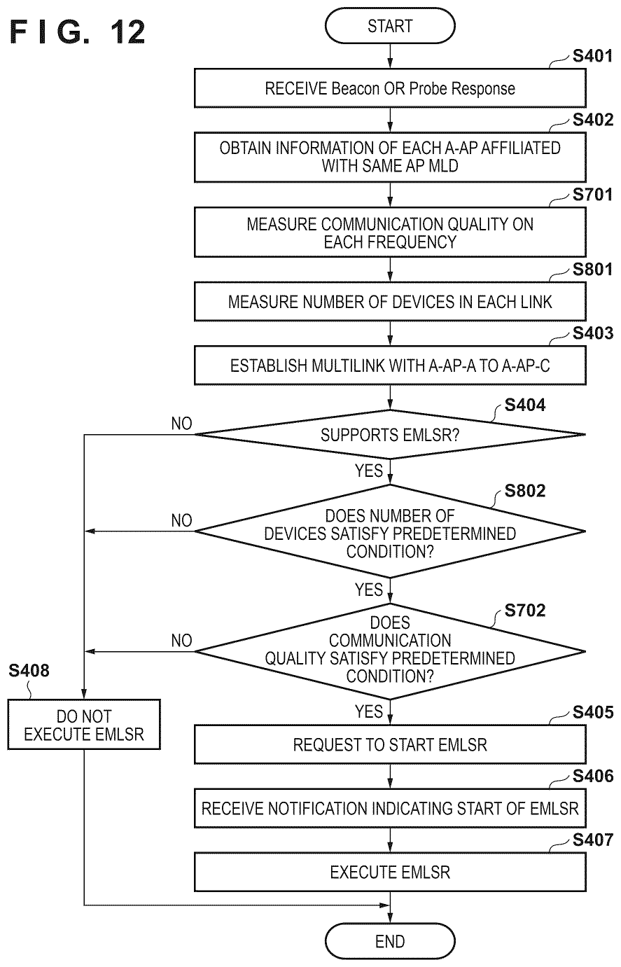

FIG. 11 shows the operation of the STA 102 in this processing. Note that in FIG. 11, operations similar to those in FIGS. 4 and 7 to 9 are given the same reference numerals, and detailed description thereof will be omitted. For example, the STA 102 obtains information regarding the A-APs affiliated with the AP 101 from Beacons or Probe Responses transmitted by the AP 101, and establishes multi-link communication with the AP 101 (steps S401, S402, and S403). Upon establishing multi-link communication with the AP 101, the STA 102 determines whether or not the AP 101 supports EMLSR (step S404). Then, upon receiving an instruction to execute EMLSR from the AP 101 (YES in step S1101), the STA 102 executes EMLSR (step S407). On the other hand, if an instruction is not received from the AP 101 (NO in step S1101), the STA 102 does not execute EMLSR (step S408). Also, if an instruction is not received from AP 101, the STA 102 may determine whether or not EMLSR is to be executed based on, for example, the processing shown in FIGS. 7 to 9 and later-described FIG. 12 and the like, and request the AP 101 to execute EMLSR based on the determination. Also, while executing EMLSR, the STA 102 can terminate EMLSR if a notification of an instruction to terminate EMLSR is received from the AP 101.

### Processing Example 5

The STA 102 may execute a combination of the above processing procedures. FIG. 12 shows an example of processing in which the STA 102 determines whether or not to execute EMLSR based on the communication quality between the AP 101 and the STA 102 and information obtained from or notified from other communication devices (e.g., the number of devices operating on the same frequency channel). Note that in FIG. 12, operations similar to those in FIGS. 4, 7 to 9, and 11 are given the same reference numerals, and detailed description thereof will be omitted. For example, when establishing multiple links with the AP 101, the STA 102 measures the communication quality of each link (step S701) and obtains the number of devices operating on the frequency channel used by each link (step S801). The method for measuring the communication quality and the method for acquiring the number of devices can be the methods described above with reference to FIGS. 7 and 8. Then, upon confirming that the AP 101 supports EMLSR (YES in step S404), the STA 102 determines whether or not the measured communication quality satisfies a predetermined condition (step S702) and whether or not the obtained number of devices satisfies a predetermined condition (step S802). The method of determining the condition regarding communication quality and the method of determining the condition regarding the number of devices can be the methods described above with reference to FIGS. 7 and 8. Then, if the predetermined condition regarding communication quality is satisfied and furthermore the predetermined condition regarding the number of devices is satisfied (YES in step S702 and YES in step S802), the STA 102 performs a procedure for executing EMLSR (steps S405 to S407). On the other hand, if at least either the predetermined condition regarding the communication quality or the predetermined condition regarding the number of devices is not satisfied (NO in step S702 or NO in step S802), the STA 102 does not execute EMLSR (step S408). Note that the condition determinations may be performed in sequence or may be performed in parallel. Furthermore, the sequence of the condition determinations may be changed. In this way, by determining whether or not to use EMLSR based on multiple conditions, it becomes possible to determine with greater accuracy whether or not to use EMLSR or multi-link communication, which uses multiple links in parallel. For example, even if there are multiple links that can provide a predetermined level of communication quality, if one of those links has a long delay, selecting EMLSR can avoid degradation of communication performance caused by increased delay.

As described above, according to the present embodiment, a communication device obtains information indicating whether or not a partner communication device is capable of executing communication using a predetermined communication method. Then, if the partner communication device is capable of executing communication using the predetermined communication method, and communication is to be executed using the predetermined communication method, communication using the predetermined communication method is started based on control performed by the partner communication device. In other words, the communication device does not simply execute communication using the predetermined communication method based on the fact that the partner communication device supports the predetermined communication method, but rather executes the predetermined communication method based on control performed by the partner communication device when the predetermined communication method is to be executed. In this way, the communication device can perform communication while appropriately switching between the predetermined communication method and normal multi-link communication in accordance with the environment. This makes it possible to improve the communication performance and power performance of multi-link communication. In the present embodiment, EMLSR is used as an example of the predetermined communication method in which multiple established links are maintained while selectively using one of the links for communication, but the present technology can also be applied to other communication methods. For example, the present invention can also be applied to a communication method in which, while maintaining multiple communication links, communication is performed by selectively using two or more of the links and not using the remaining links. In this case, the communication device can select multiple links with good communication quality or the like from the multiple maintained links, and perform communication using the selected links.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002046, filed Jan. 10, 2024, which is hereby incorporated by reference herein in its entirety.

What is claimed is:

1. A communication device, comprising:
an establishing unit configured to establish a plurality of communication links with another communication device;
an obtaining unit configured to obtain information indicating whether or not the another communication device is capable of executing communication using a predetermined communication method in which, while maintaining the plurality of communication links, communication is performed selectively using a portion of the plurality of communication links and not using a remaining portion of the plurality of communication links; and
a communication unit configured to, in a case where the another communication device is capable of executing communication using the predetermined communication method, and communication using the predetermined communication method is to be executed, start communication using the predetermined communication method based on control performed by the another communication device.

2. The communication device according to claim 1, further comprising:
a determination unit configured to execute an execution determination regarding whether or not communication using the predetermined communication method is to be started, wherein
in a case where the execution determination determines that communication using the predetermined communication method is to be executed, the communication unit requests the another communication device to start communication using the predetermined communication method.

3. The communication device according to claim 2, wherein
in a case where the plurality of communication links includes one or more communication link for which a value indicating communication quality is lower than a predetermined threshold value, the determination unit determines that communication using the predetermined communication method is to be executed.

4. The communication device according to claim 3, wherein
the value indicating communication quality is a received signal strength indicator (RSSI) or a signal to noise ratio (SNR).

5. The communication device according to claim 2, wherein
the determination unit is further configured to estimate, for each of a plurality of frequency channels respectively corresponding to the plurality of communication links, the number of devices operating on each of the plurality of frequency channels, and in a case where the plurality of frequency channels include one or more frequency channel for which the estimated number of devices is above a predetermined threshold value, the determination unit determines that communication using the predetermined communication method is to be executed.

6. The communication device according to claim 2, wherein
in a case where the communication device is operating in a power saving operation mode, the determination unit determines that communication using the predetermined communication method is to be executed.

7. The communication device according to claim 2, wherein
in a case where a remaining battery amount of the communication device is a predetermined threshold value or less, the determination unit determines that communication using the predetermined communication method is to be executed.

8. The communication device according to claim 1, wherein
in a case where an instruction indicating execution of communication using the predetermined communication method is received from the another communication device, the communication unit starts communication using the predetermined communication method.

9. The communication device according to claim 2, wherein
the determination unit is further configured to, while the communication unit is executing communication using the predetermined communication method, execute a continuation determination regarding whether or not communication using the predetermined communication method is to be continued, and
in a case where the continuation determination determined that communication using the predetermined communication method is not to be continued, the communication unit requests the another communication device to terminate communication using the predetermined communication method.

10. The communication device according to claim 8, wherein
in a case where an instruction indicating termination of communication using the predetermined communication method is received from the another communication device, the communication unit terminates communication using the predetermined communication method.

11. The communication device according to claim 1, wherein
the communication device includes a plurality of communication circuits respectively corresponding to the plurality of communication links.

12. A communication device, comprising:
an establishing unit configured to establish a plurality of communication links with another communication device;
a notification unit configured to notify information indicating whether or not the communication device is capable of executing communication using a predetermined communication method in which, while maintaining the plurality of communication links, communication is performed selectively using a portion of the plurality of communication links and not using a remaining portion of the plurality of communication links;
a determination unit configured to, in a case where the another communication device is capable of executing communication using the predetermined communication method, execute an execution determination regarding whether or not to cause the another communication device to execute communication using the predetermined communication method; and
a control unit configured to, in a case where the execution determination determined to cause the another communication device to execute communication using the predetermined communication method, perform control such that the another communication device executes communication using the predetermined communication method.

13. The communication device according to claim 12, wherein
the determination unit executes the execution determination based on a request from the another communication device, and
in a case where the execution determination determined to cause the another communication device to execute communication using the predetermined communication method, the control unit instructs, in a response to the request, the another communication device to execute communication using the predetermined communication method.

14. The communication device according to claim 12, wherein
the control unit transmits an instruction to execute communication using the predetermined communication method to the another communication device.

15. The communication device according to claim 12, wherein
in a case where the plurality of communication links includes one or more communication link for which a value indicating communication quality is lower than a predetermined threshold value, the determination unit determines to cause the another communication device to execute communication using the predetermined communication method.

16. The communication device according to claim 15, wherein
the value indicating communication quality is a received signal strength indicator (RSSI) or a signal to noise ratio (SNR).

17. The communication device according to claim 12, wherein
the determination unit is further configured to estimate, for each of a plurality of frequency channels respectively corresponding to the plurality of communication links, the number of devices operating on each of the plurality of frequency channels, and in a case where the plurality of frequency channels include one or more frequency channel for which the estimated number of devices is above a predetermined threshold value, the determination unit determines to cause the another communication device to execute communication using the predetermined communication method.

18. The communication device according to claim 12, wherein
in a case where, while the another communication device is executing communication using the predetermined communication method, the another communication device is determined not to continue communication using the predetermined communication method, the determination unit controls the another communication device to terminate communication using the predetermined communication method.

19. The communication device according to claims 1, wherein
the communication device includes a plurality of communication circuits respectively corresponding to the plurality of communication links.

20. A non-transitory computer readable storage medium that stores a program for causing a computer included in a communication apparatus to perform a method comprising:
establishing a plurality of communication links with another communication device;
obtaining information indicating whether or not the another communication device is capable of executing communication using a predetermined communication method in which, while maintaining the plurality of communication links, communication is performed selectively using a portion of the plurality of communication links and not using a remaining portion of the plurality of communication links; and
starting, in a case where the another communication device is capable of executing communication using the predetermined communication method, and communication using the predetermined communication method is to be executed, communication using the predetermined communication method based on control performed by the another communication device.
